(19) United States
(12) Patent Application Publication
(10) Pub. No.: US 2009/0134543 A1
(43) Pub. Date: May 28, 2009

(54) Vacuum Film Forming Apparatus and Vacuum Film Forming Method

(75) Inventors: Takao Umezawa, Maeba-shi (JP); Atsuo Kitazume, Isesaki-shi (JP); Hiroshi Takano, Oizumi-machi (JP); Fusami Oyama, Oura (JP)

Correspondence Address: OLIFF & BERRIDGE, PLC, P.O. BOX 320850, ALEXANDRIA, VA, 22320-4850, US

(73) Assignee: OSHIMA ELECTRIC WORKS CO., LTD., Ota-shi ,Gunma (JP)

(21) Appl. No.: 11/991,841

(22) PCT Filed: Sep. 11, 2006
(86) PCT No.: PCT/JP2006/317954

§ 371 Date: Mar. 12, 2008

(30) Foreign Application Priority Data
Sep. 16, 2005 (JP) 2005-270222

(51) Int. Cl. B29C 39/00

(52) U.S. Cl. 264/101; 425/145

(57) ABSTRACT

A vacuum film forming apparatus includes a target chamber in which a target is disposed for performing a vacuum film forming; a first mold at a side of the target chamber; and a second mold that includes a workpiece chamber in which a workpiece is capable of being disposed. The first mold and the second mold are structured such that a film being formed onto the workpiece is capable of being carried out by die matching between the first mold and the second mold, and a shutter device for opening and closing the target chamber is provided to the first mold.

### CROSS-REFERENCE TO RELATED APPLICATIONS

This application is the U.S. National Stage of PCT/JP2006/317954, filed Sep. 11, 2006, which claims priority from JP2005-270222, filed Sep. 16, 2005, the entire disclosures of which are incorporated herein by reference hereto.

### BACKGROUND

The present disclosure relates to a vacuum film forming apparatus and method.

There exists a sputtering system of a vacuum film forming apparatus in which plasma is generated by exciting an argon gas in a vacuum. The plasma is made to collide with a target that serves as a film-forming material in order to scatter particles of the film-forming material in a film forming processing chamber. The sputtered particles are applied to a surface of a workpiece (a member to be processed for film forming) that is disposed in the film forming processing chamber. As a result, a film is formed.

For example, a vacuum film forming apparatus disclosed by Japanese Patent No. 3677033 includes a first mold, in which a film forming device is built-in that forms a film onto a workpiece, and a second mold, in which a workpiece is built-in onto which a film is formed. The first mold is thrust onto the second mold so that vacuum film forming is performed in a thrusting state. According to the disclosure, it is possible to form a workpiece and to form a film by a series of molding. The production efficiency and the quality of film-formed molded products has been greatly improved. As a result, a rejection rate is considerably reduced and working efficiency is increased.

In such a device, however, each time the film forming process is applied, it is necessary to repeatedly carry out a step where an interior of a film forming processing chamber is shifted from an atmospheric pressure to a vacuum, and back to an atmospheric pressure. In other words, it takes time to make the air in the film forming processing chamber from an atmospheric pressure state into a vacuum state by using a pump. Therefore, workability has yet to be satisfactory.

In order to overcome the problem, a proposed film forming processing chamber is provided with a shutter so as to be partitioned into a workpiece chamber and a target chamber. In the workpiece chamber side, a processing of an interior is repeated in that an atmospheric pressure is shifted to a vacuum, and back to an atmospheric pressure. A vacuum state is maintained in the target chamber side. In order to facilitate replacement of such a target, the film forming processing chamber is partitioned into the workpiece chamber side and the target chamber side with the shutter (see Japanese Published Unexamined Patent Application No. H9-31642, for example).

### SUMMARY

However, such a structure of the proposed film forming processing chamber, which is provided with the shutter so as to be partitioned, is mainly for the purpose of replacing the target. In other words, the structure is not quite configured for frequent shutter opening and closing. In such a device where a workplace is subject to film forming processing, a workpiece chamber side is shifted from an atmospheric pressure to a vacuum, and from the vacuum to an atmospheric pressure. There is no mention of a concrete structure for such a desired shutter. In particular, while the work chamber is shifted from an atmospheric pressure to a vacuum and from a vacuum to an atmospheric pressure because of moving and/or taking out a workpiece, the target chamber side is provided with the shutter in order to maintain the target chamber side in a vacuum state. In this case, the shutter needs reliable and smooth opening and closing, and close sealing. The present disclosure solves the problem as well as other problems and is also be able to achieve various advantages.

The present disclosure addresses an exemplary aspect of a vacuum film forming apparatus that includes a target chamber in which a target is disposed for performing a vacuum film forming; a first mold at a side of the target chamber; and a second mold that includes a workpiece chamber in which a workpiece is capable of being disposed. The first mold and the second mold are structured such that a film being formed onto the workpiece is capable of being carried out by die matching between the first mold and the second mold, and a shutter device for opening and closing the target chamber is provided to the first mold.

In another exemplary aspect, the shutter device includes a base that is supported on an open end of the first mold; and an opening and closing member that opens and closes an opening of the base so as to control communication between the target chamber and the workpiece chamber.

In another exemplary aspect, the base includes a first supporting plate that is supported to a side of the first mold; and a second supporting plate provided so as to be laminated onto the first supporting plate, wherein the opening and closing member is disposed so as to be freely movable between both supporting plates.

In another exemplary aspect, between the opening and closing member and the base is a guide that guides the opening and closing member to be displaced toward a side of the second supporting plate while moving the opening and closing member into a position in which the opening is closed, and the guide places the opening and closing member into a state in which the opening and closing member touches the side of the second supporting plate in a sealed manner so as to be spaced from a plate surface of the first supporting plate in the position in which the opening is closed so that a vacuum state is maintained in the target chamber.

In another exemplary aspect, while moving from a closed state to an open state, the opening and closing member is displaced toward a plate surface side of the first supporting plate by receiving atmospheric pressure from the workpiece chamber that is thrust onto the second supporting plate in a sealed manner.

In another exemplary aspect, a vacuum film forming method includes the successive steps of carrying out die matching between a first mold that is located at a side of a target chamber in which a target is disposed to perform vacuum film forming, and a second mold that includes a workpiece chamber in which a workpiece is disposed; and forming a film onto the workpiece. When a shutter device that is provided to the first mold in order to open and close the target chamber is shifted to an open position while die matching of the molds is carried out and the film is formed, a vacuum film forming is applied onto the workpiece, and the shutter is shifted to a closed position after the vacuum film forming is completed until a following die matching is carried out so that the target chamber is maintained in a vacuum state.

According to various exemplary aspects, the target chamber can be kept in a vacuum state, manufacturing time (a vacuum process time) can be shortened, and the workability can be improved, which contributes to a reduction in cost.

According to various exemplary aspects, the opening and closing member can become smoothly open and closed.

According to various exemplary aspects, at a closed position of the opening and closing member, the sealing performance of the target chamber can be improved.

### BRIEF DESCRIPTION OF THE DRAWINGS

Various embodiments of the present disclosure will be described with reference to the drawings, wherein:

FIG. 1 is a cross sectional view of a film-formed molded piece;

FIG. 2 is a schematic diagram of a film forming apparatus;

FIGS. 3A, 3B, 3C, and 3D are schematic diagrams showing first half manufacturing processes for manufacturing the film-formed molded piece;

FIGS. 4A, 4B, 4C, and 4D are schematic diagrams showing middle manufacturing processes for manufacturing the film-formed molded piece;

FIGS. 5A, 5B, 5C, and 5D are schematic diagrams showing latter half manufacturing processes for manufacturing the film-formed molded piece;

FIG. 6A is a cross sectional view taken along the line X-X of FIG. 6B, and

FIG. 6B is a bottom plan view of the shutter device;

FIG. 7A is a cross sectional view taken along the line X-X of FIG. 7B, FIG. 7B is a bottom plan view of a first supporting plate, and FIG. 7C is a cross sectional view taken along the line Y-Y of FIG. 7B;

FIG. 8A is a cross sectional view taken along the line X-X of FIG. 8B, FIG. 8B is a bottom plan view of a second supporting plate, and FIG. 8C is a cross sectional view taken along the line Y-Y of FIG. 8B;

FIG. 9A is a front view and FIG. 9B is a bottom plan view of a shutter;

FIG. 10A is a front view of a guide member, FIG. 10B is a bottom plan view of a joint tool, FIG. 10C is a cross-sectional view taken along the line X-X of FIG. 10B, and FIG. 10D is a side view of FIG. 10B; and

FIG. 11A is a cross-sectional view taken along the line X-X of FIG. 11B and FIG. 11B is a main part enlarged view for explanation of an open/closed state of the shutter.

### DETAILED DESCRIPTION OF PREFERRED EMBODIMENTS

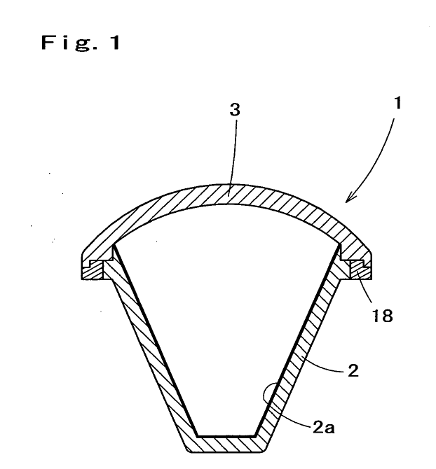

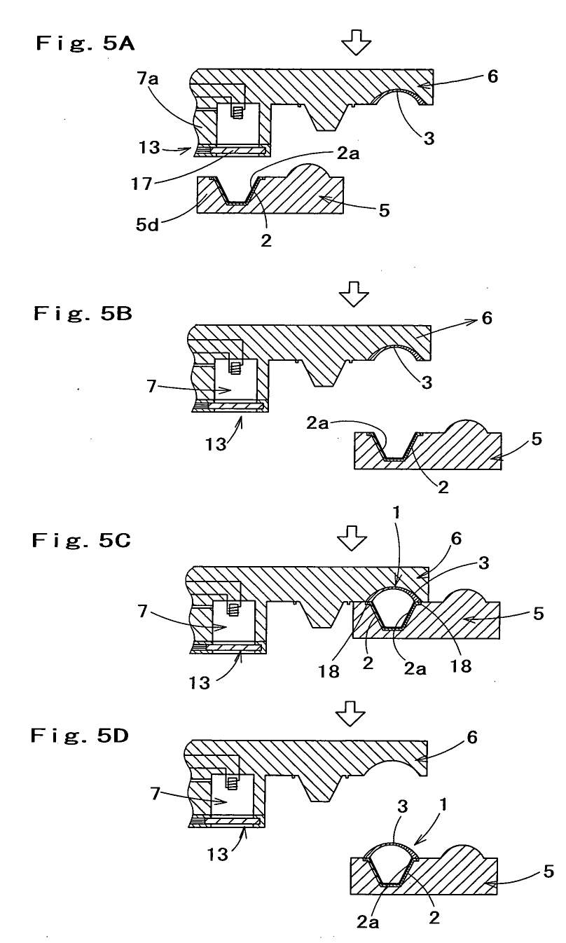

Next, an embodiment of the present disclosure will be described with reference to the drawings. In FIGS. 1, 5C, and 5D, reference numeral 1 is a film-formed molded piece. The film-formed molded piece 1 is manufactured via a secondary injection step that integrates a first molded piece 2 and a second molded piece 3 that are formed in molds at a primary injection step. A film forming 2a is applied to the first molded piece 2 (corresponding to a workpiece in the present disclosure) by a film forming step that is provided between the primary and the secondary injection steps (see FIGS. 1, 4D, and 5A-5D).

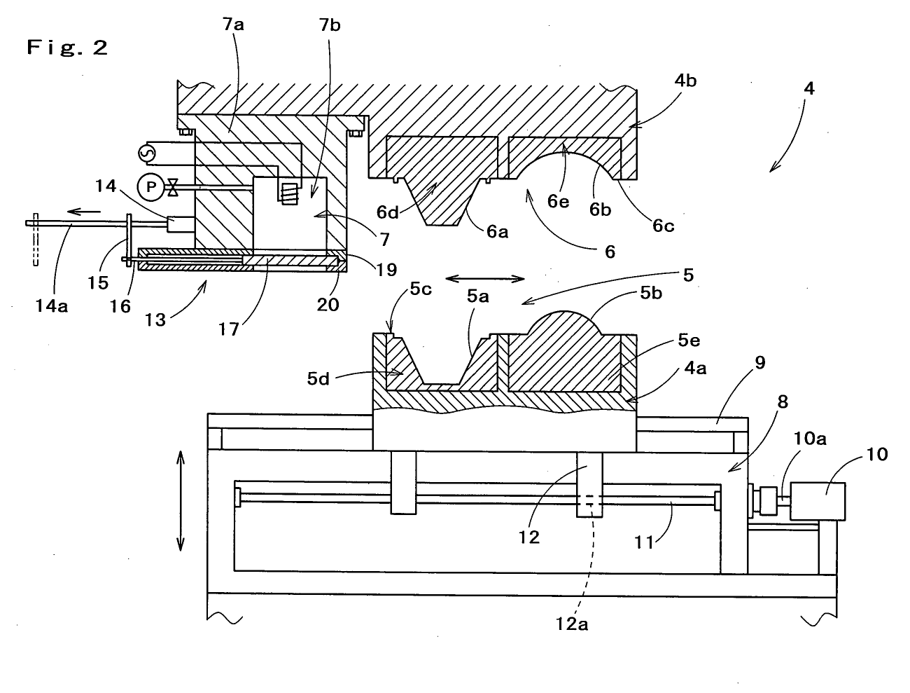

As shown in FIG. 2, the manufacturing device 4 for manufacturing the film-formed molded piece 1 comprises a movable side mold base 4a and a fixed side mold base 4b, which will be described later. At the movable side mold base 4a, molding dies 5d and 5e in which mold faces 5a and 5b for forming shapes of the first and second molded pieces 2 and 3 are formed on a mold surface 5c are respectively detachably provided, and a movable mold 5 is composed of those.

As shown in FIG. 2, at the fixed side mold base 4b, molding dies 6d and 6e, in which mold faces 6a and 6b that form shapes of the first and second molded pieces 2 and 3 are formed on a mold surface 6c, and a film forming die (corresponding to a first mold in the present disclosure) 7a that is disposed at a side adjacent to a first molding die surface 6a of the molding dies 6d and 6e and is equipped with a vacuum film forming apparatus 7 (a vacuum film forming apparatus that forms a film by vacuum deposition, sputtering deposition, or the like), which will be described later, are detachably provided in a straight line. The fixed mold 6 comprises these molding dies 6d and 6e and the film forming die 7a.

The movable mold 5 (the movable side mold base 4a) is provided on a mounting base 8 on which the molds adjacently move one another by use of an actuator that is unillustrated (see FIG. 2). On the mounting base 8, also provided is a guide rail 9 that is directed in the same direction as a direction in which the mold faces 6a and 6b of the fixed mold 6 and the film forming die 7a are allocated. The movable mold 5 is provided to be freely-movable to the guide rail 9, so that the movable mold 5 can move in a direction along the mold surface 5c (a horizontal direction in FIG. 2).

Reference numeral 10 denotes an actuator for movement that is provided to the mounting base 8 (see FIG. 2) and comprises a servo motor that is capable of controlling driving energy (a rotational quantum) in the present embodiment. A screw shaft 11 that is disposed in a state parallel to the guide rail 9 is fixedly attached to an output shaft 10a of the actuator 10. The movable mold 5 is provided with an operating member 12 on which a male screw 12a, with which the screw shaft 11 is screwed together, is threaded. In conjunction with the actuator 10 being driven positively and negatively, the movable mold 5 performs a movement that is guided by the guide rail 9 (see FIG. 2).

In order to open and close a leading end portion of the film forming die 7a, a shutter device 13, which will be described later, is provided to the vacuum film forming apparatus 7 (see FIGS. 2, 3A-3D, 4A-4D, and 5A-5D). The shutter device 13 is opened and closed by driving an actuator 14. From the actuator 14 of the shutter device 13, a screw shaft (driving shaft) 14a projects in a direction along the mold surface 6c (see FIG. 2). An operating member 15 is threadably mounted on the screw shaft 14a. The operating member 15 moves along the screw shaft 14a in conjunction with positive and negative driving of the actuator 14 (see FIG. 2).

A guide member 16 is integrally joined to a leading end portion of the operating member 15 (see FIG. 2). A shutter 17 (corresponding to an opening and closing member of the present disclosure) is provided to a leading end portion of the guide member 16 (see FIG. 2). That is, the shutter device 13 is configured to open and close the leading end opening of the film forming die 7a based on the fact that the shutter 17 is displaced by a movement of the operating member 15 based on the positive and negative driving of the actuator 14.

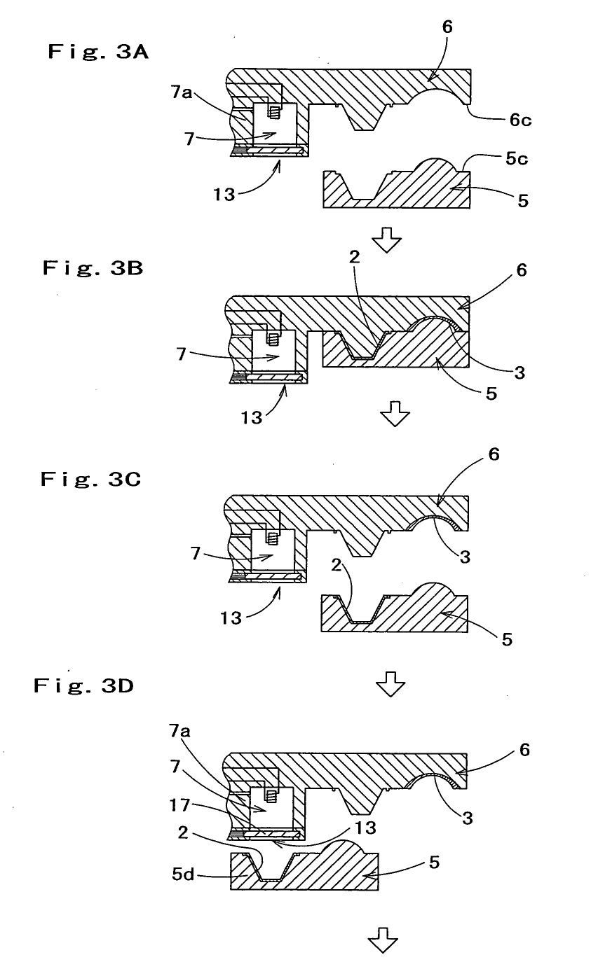

Next, manufacturing processes of the film-formed molded piece 1 that is manufactured by implementing the present disclosure will be described by use of FIGS. 3A-3D, 4A-4D, and 5A-5D. First, from a state in which the mold surface 5c faces the mold surface 6c of the fixed mold 6, the movable mold 5 moves in a direction toward the fixed mold 6 in order to carry out die matching (see FIG. 3A). In the die matching state, the primary injection step is then performed in which the first and second molded pieces (first and second workpieces) 2 and 3 are injection-molded (see FIG. 3B).

Subsequently, the movable mold 5 moves in a mold separation direction. At this time, the first molded piece 2 is configured to remain on the side of the movable mold 5, and the second molded piece 3 is configured to remain on the side of the fixed mold 6 (see FIG. 3C).

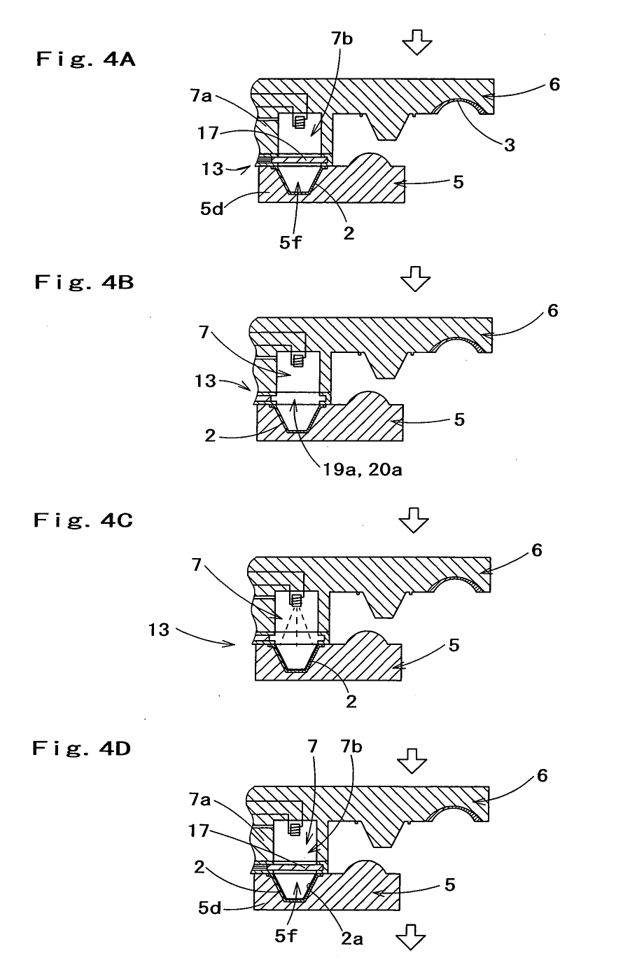

Thereafter, the movable mold 5 moves in a direction (to the left in the drawing) along the mold surface 5c such that the first molding die 5d that corresponds to a second mold in the present disclosure faces the film forming die 7a (see FIG. 3D). After that, the movable mold 5 moves in a direction of die matching in order to carry out die matching of the molds 5d and 7a (see FIG. 4A). Until the die matching is completed, the shutter 17 of the shutter device 13 remains closed and the target chamber 7b remains in a vacuum. After the die matching is completed, the shutter 17 moves in an opening direction so as to be at an open position based on the driving of the actuator 14. In accordance therewith, the shutter device 13 is shifted at a position such that the target chamber 7b of the film forming die 7a and the first molding die 5d (the workpiece chamber 5f) are communicated with one another (see FIG. 4B).

In the state above, when a vacuum pump P operates in order to form a desired vacuum state of an interior of the film forming apparatus 7 (a vacuum process) and acquires a desired vacuum film forming condition, the film forming 2a is applied onto a plane that is separated from the mold face 6a of the first molded piece 2 (a film forming process, see FIG. 4C). After the film forming 2a is applied, the shutter 17 moves to a closing direction based on negative driving of the actuator 14. The shutter device 13 thus closes an inside of the film forming die 7a in a hermetically-sealed manner (see FIG. 4D). This hermetically-sealed closure is to be maintained up to a next film forming step (a die matching process for forming a film).

Next, the movable mold 5 moves to a mold separation direction so as to be separated from the mold of the film forming apparatus 7 (see FIG. 5A). Subsequently, the movable mold 5 moves in a direction along the mold surface 5c (to the right in the drawing), and the first molded piece 2 and the second molded piece 3 face one another (see FIG. 5B). In addition, when members such as a light source and the like are necessary to be installed in the first and second molded pieces 2 and 3, a mounting process of the necessary members can be provided at a stage at which the film forming 2a is applied onto the first molded piece 2 that is separated from the mold thereafter (a stage of FIG. 5A) or at a stage at which the first and second molded pieces 2 and 3 are made to face one another (a stage of FIG. 5B).

Then, die matching of the molds 5 and 6 is carried out in a state in which the first and second molded pieces 2 and 3 face one another. The first and second molded pieces 2 and 3 are integrated with a resin material 18, which executes the secondary injection step (see FIG. 5C) for manufacturing the film-formed molded piece 1. After that, the movable mold 5 moves in a mold separation direction, and the film-formed molded piece 1 is ejected (see FIG. 5D). The movable mold 5 then moves in a direction along the mold surface (to the left in the drawing) such that the mold faces 5a and 6a, and 5b and 6b, corresponding to one another, face one another. By repeating a series of these steps, the film-formed molded piece 1 can be manufactured in succession. That is, the film-formed molded piece 1 is manufactured via the primary molding, the film forming, and the secondary molding.

Now, the shutter device 13 that is provided to the vacuum film forming apparatus 7 to which the present disclosure has been implemented will be described in detail. The shutter device 13 is, as described above, provided to an open end of the film forming die 7a of the vacuum film forming apparatus 7, and comprises the actuator 14, the operating member 15, the guide member 16, and the shutter 17 (see FIG. 2). The shutter device 13 further comprises a base of the present disclosure that is supported (fixed) to the open end of the film forming die 7a. The base of the shutter device 13 comprises first and second supporting plates 19 and 20 that are disposed in a laminated state. Continuous holes 19a and 20a for scattering target particles that are open through these first and second supporting plates 19 and 20 are opened and closed by the shutter 17 that is installed so as to be freely movable between the first and second supporting plates 19 and 20.

In the steps of forming the film-formed molded piece 1, the first molding die 5d is thrust onto an outer rim portion at which the shutter 17 is installed of the shutter device 13 that is disposed at an open end of the film forming die 7a, so that die matching is carried out in a state in which the outer rim portion is covered in a sealed manner. The target chamber 7b at a side of the film forming die 7a in which the film forming apparatus 7 is installed and the workpiece chamber 5f at a side of the first molding die 5d are partitioned by the shutter device 13 (refer to FIG. 4A). As the shutter 17 is shifted to an open position, the target chamber 7b and the workpiece chamber 5f communicate with one another through the continuous holes 19a and 20a (refer to FIG. 4B). Now, descriptions of the shutter device 13 will be hereinafter carried out in a state in which the installed state of FIG. 2 is defined as a front view.

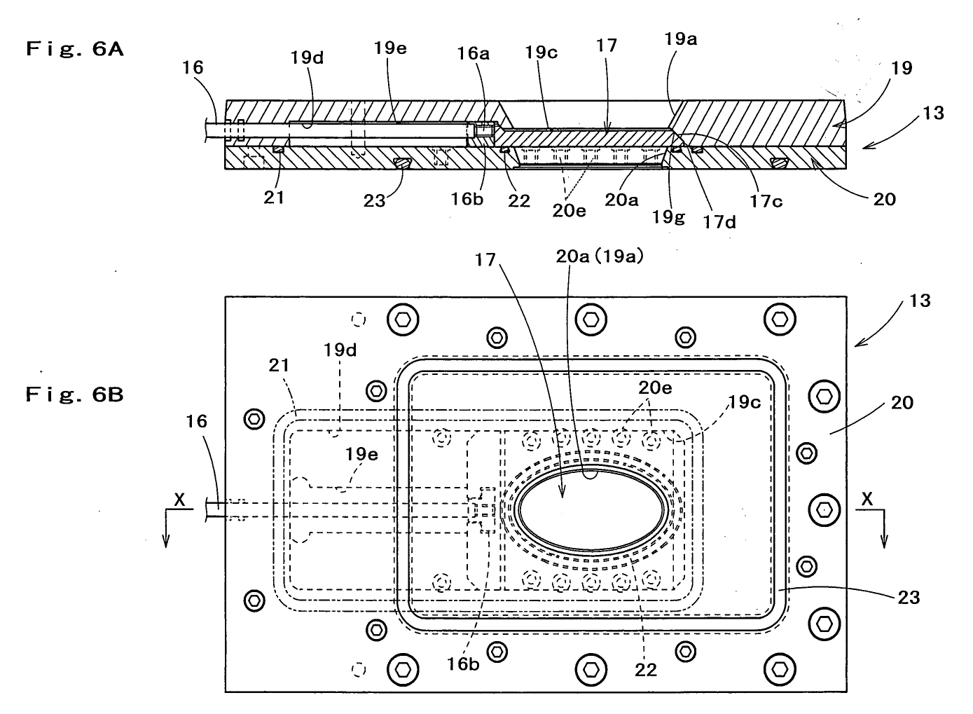

The first supporting plate 19 is a plate that is disposed so as to be located at a side of the target chamber 7b (the upper side) as shown in FIG. 2. The first continuous hole 19a for scattering a target is open at a substantially central part (see FIGS. 6A, 6B, 7A, 7B, 7C, 11A, and 11B). At a lower side surface (a plate surface at a side of the second supporting plate 20) at an outer peripheral portion of the first continuous hole 19a, formed is a rectangular first concave portion 19c whose groove depth is set to be H1. At a lower side 19b of the first supporting plate 19, formed is a rectangular second concave portion 19d that is located at a left side of the first concave portion 19c (at a side at which the actuator 14 is installed) and whose groove depth is set to be H2 that is deeper than H1 of the first concave portion 19c. A third concave portion 19e is formed so as to be located at a central part in an anteroposterior direction of the second concave portion 19d and have a groove depth that is set to be H3 that is deeper than H2 of the second concave portion 19d.

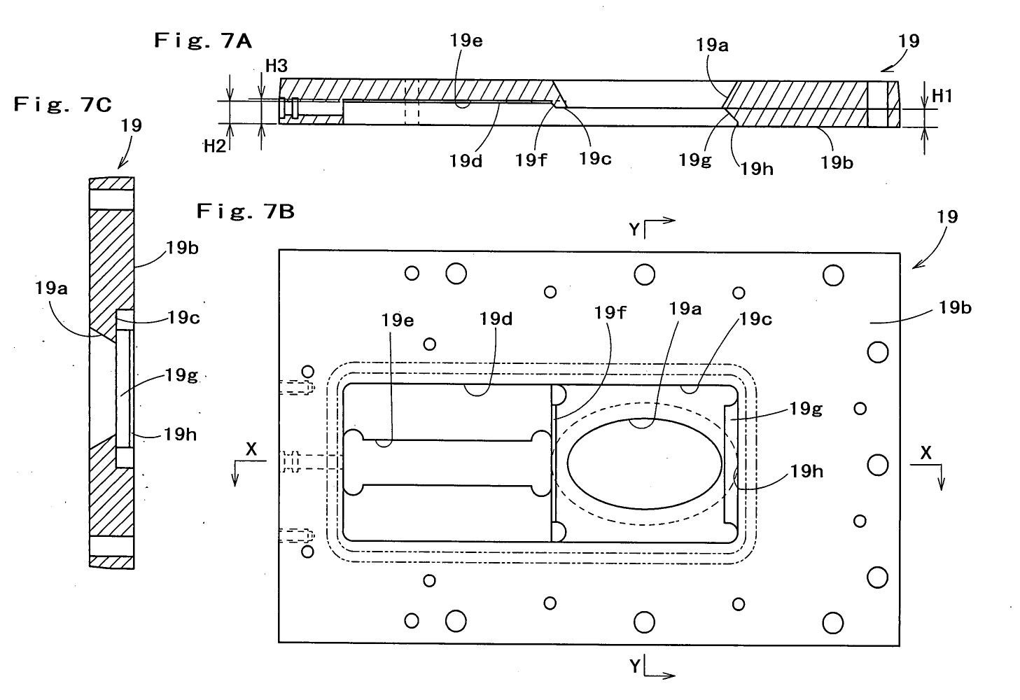

At a left edge portion of the first concave portion 19c, between the first concave portion 19c and the second concave portion 19d or the third concave portion 19e that are adjacent, formed is a left inclined plane 19f whose left edge end portion deviates more toward a side of the target chamber 7b (see FIG. 7A). At a right edge portion of the first concave portion 19c, between the first concave portion 19c and a lower side surface 19b, formed is an inclined guide plane 19g whose right edge end portion deviates more toward a lower (second supporting plate 20) side and that structures a guide of the present disclosure. In addition, a movement restriction plane 19h that is directed in a vertical direction is formed at a lower edge portion of the inclined guide plane 19g.

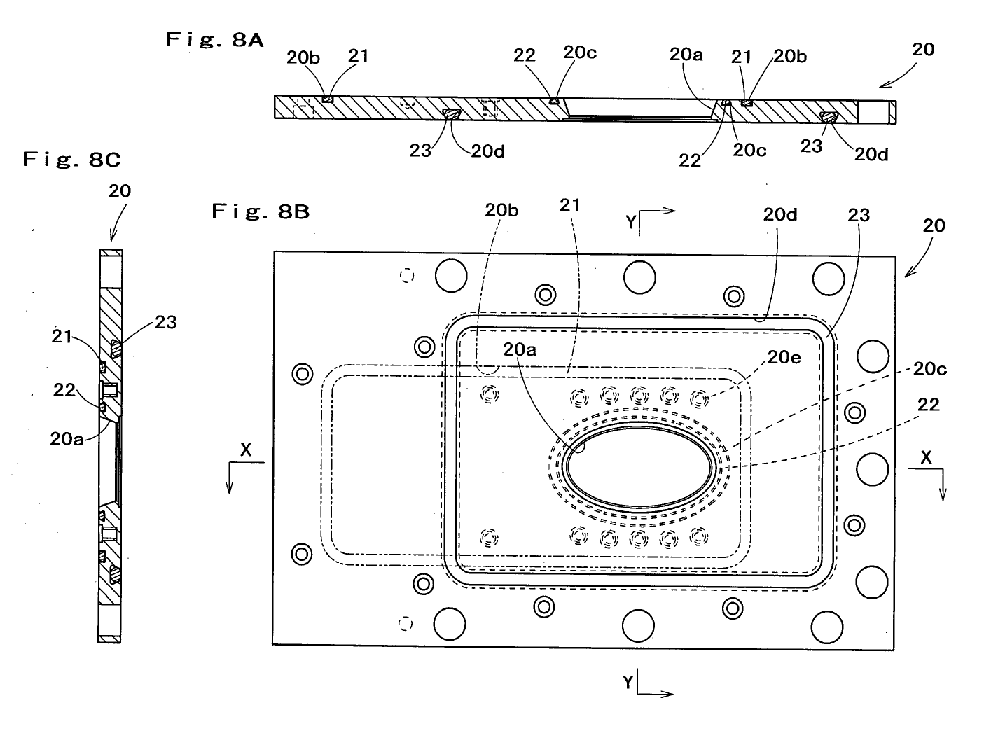

The second supporting plate 20 is disposed so as to be located at the workpiece chamber 5f (a lower side) as shown in FIG. 2. The second supporting plate 20 also has a tabular plate surface, and the second continuous hole 20a that communicates with the first continuous hole 19a is open therein (see FIGS. 6A, 6B, 8A, 8B, and 8C). The second supporting plate 20 is integrated with the first supporting plate 19 so as to be laminated in a thrust state, so that clearances, corresponding to the groove depths H1, H2, and H3 of the first, second, and third concave portions 19c, 19d, and 19e, are formed between the first and second supporting plates 19 and 20. The guide member 16 and the shutter 17 are installed so as to be horizontally freely movable in the clearances.

Reference numeral 21 denotes a first sealing material that is disposed in a sealing hole 20b that is concaved in a plate surface (an upper side surface) at the first supporting plate 19 side of the second supporting plate 20 (see FIGS. 8A and 8b), and is configured to touch a lower side surface 19b of the first supporting plate 19 to seal between those. Reference numeral 22 is a second sealing material that is disposed in a sealing hole 20c that is concaved in the upper side surface (see FIGS. 8A and 8B), and is configured to touch a lower side surface of the shutter 17 at a closed position so as to form a seal. Reference numeral 23 is a third sealing material that is disposed in a sealing hole 20d that is concaved in a plate surface at the workpiece chamber 5f side of the second supporting plate 20 (see FIGS. 8A and 8B), and is configured to touch an open end plane of the first molding die 5d onto which die matching has been carried out in order to form a seal.

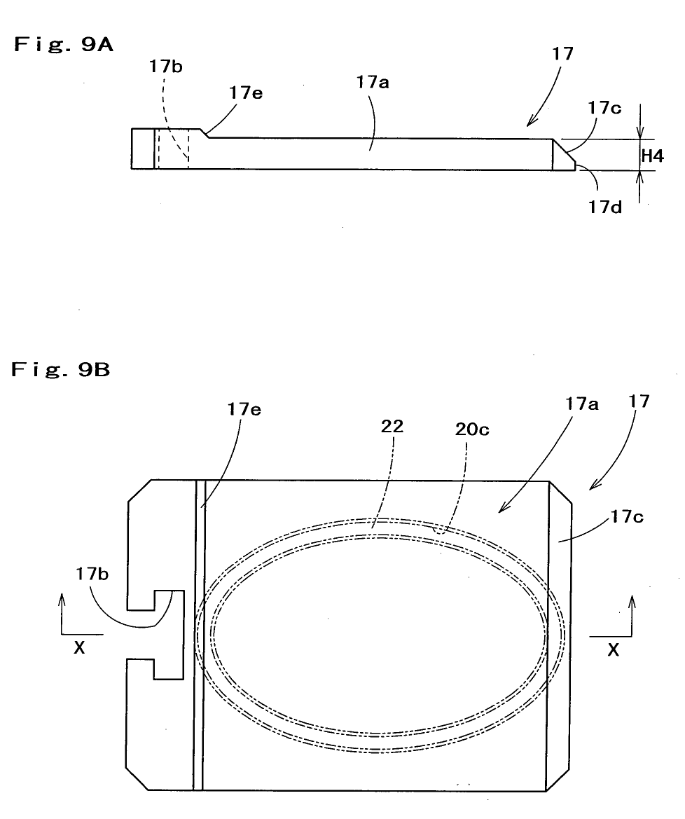

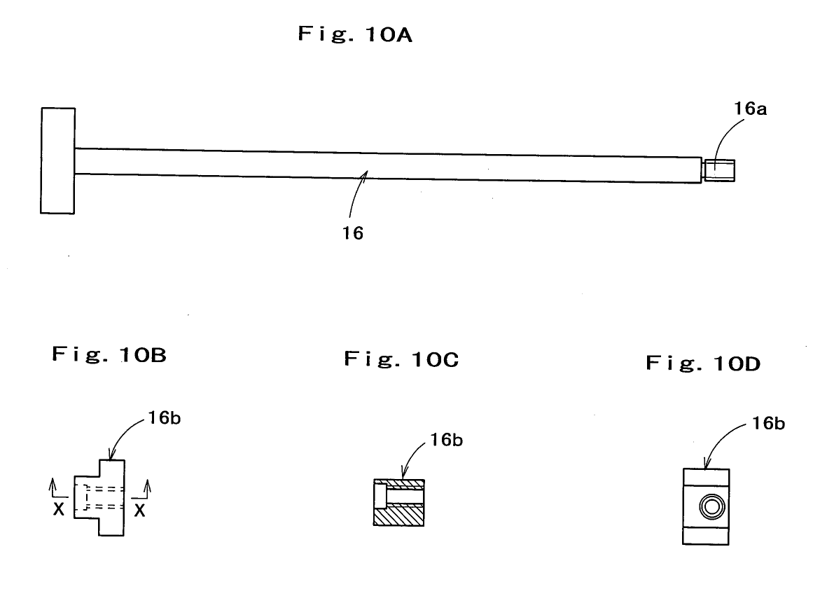

The shutter 17 has a board thickness H4 that is thinner than the groove depth of H1 of the first concave portion 19c (see FIG. 9A). The shutter 17 also comprises a rectangular main body part 17a that is substantially the same shape as the first concave portion 19c. The main body part 17a is configured to cover (close) the first and second continuous holes 19a and 20a. A dovetail groove-like concave portion 17b is formed so as to vertically pass through at a left side portion of the shutter main body part 17a. A joint tool 16b with which a right end 16a of the guide member 16 is threadably mounted and integrated is fitted so as to freely slide vertically (to be freely-movable relatively) into the concave portion 17b. The shutter 17 and the guide member 16 are horizontally housed in a freely-movable state in the clearances that are formed between the first and second supporting plates 19 and 20, and shift positions between a closed position at which the shutter 17 and the guide member 16 are located at a right side of the first and second supporting plates 19 and 20 so as to close the continuous holes 19a and 20a, and an open position at which the shutter 17 and the guide member 16 are located at a left side of the first and second supporting plates 19 and 20 so as to open the continuous holes 19a and 20a.

At a right edge portion of the shutter main body part 17a, formed are an inclined guide plane 17c that has an inclined plane that deviates downward more toward a right end side of the inclined guide plane 17c and a movement restriction plane 17d that is located at a lower edge portion of the inclined guide plane 17c so as to be vertically directed. The inclined guide plane 17c and the movement restriction plane 17d face the inclined guide plane 19g and the movement restriction plane 19h that are formed at the right edge portion of the first concave portion 19c of the first supporting plate 19. A portion in which the concave portion 17b of the shutter 17 is formed, is formed so as to have a thick board thickness and swell out upward more than a top surface of the main body part 17a. Accordingly, an upper side inclined plane 17e is formed between the main body part 17a and the concave portion 17b forming portion.

In the shutter device 13 structured in this way, at the closed position of the shutter 17 in which the continuous holes 19a and 20a are closed, the shutter main body part 17a is in a state in which the inclined guide plane 17c that is formed at the right edge touches the inclined guide plane 19g of the first supporting plate 19, the movement restriction plane 17d touches the movement restriction plane 19h of the first supporting plate 19, and the upper side inclined plane 17e touches the left inclined plane 19f of the first supporting plate 19. In accordance therewith, because a lower surface of the shutter main body part 17a touches a tabular top surface of the second supporting plate 20 in a closely-contacted manner, the second continuous hole 20a is reliably sealed.

As shown in FIG. 4A, the operation is set such that, in a state in which die matching is carried out between the film forming die 7a and the first molding die 5d, and the first molding die 5d is thrust onto the shutter device 13, the shutter 17 of the shutter device 13 is at a closed position, and in accordance therewith, the shutter device 13 partitions between the target chamber 7b at the film forming die 7a side and the workpiece chamber 5f at the first molding die 5d side. At this time, the first molding die 5d is structured such that the mold surface 5c is thrust onto the second supporting plate 20, and the mold face 5a is located at an inner side of the third sealing material 23 of the second supporting plate 20 so as to seal the workpiece chamber 5f.

From the state in which die matching has been carried out, the shutter 17 is shifted to an open position in order to form a film onto the first molded piece 2. When the guide member 16 is forcibly displaced to the left by driving the actuator 14, the target chamber 7b side is in a vacuum state, and the workpiece chamber 5f side is in an atmospheric pressure state. The shutter main body part 17a is thus pressed toward the target chamber 7b side. That is, the shutter main body part 17a is configured such that the inclined guide plane 17c at a right end side is pressed onto a bottom surface of the first concave portion 19c, i.e., a hole rim of the first continuous hole 19a in a state of being along the inclined guide plane 19g of the first supporting plate 19 in accordance with the forcible displacement to the left. The shutter main body part 17a is thus configured so as to be displaced toward the first supporting plate 19 side with respect to the joint tool 16b, so that an opening operation along the first concave portion 19c of the first supporting plate 19 is performed.

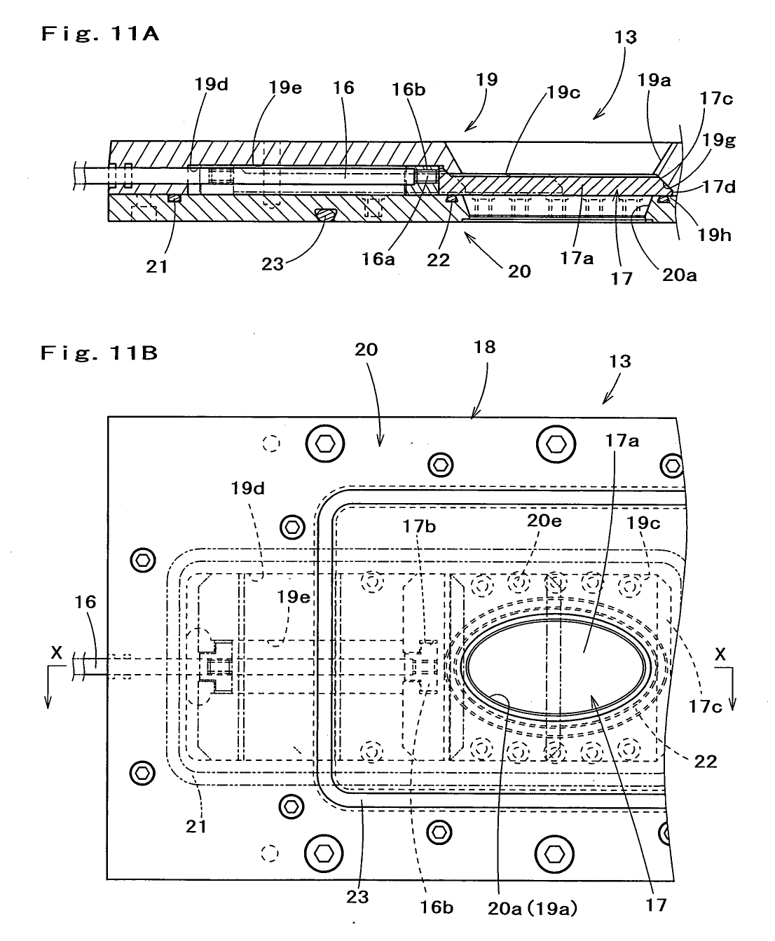

At this time, because the second concave portion 19d in the groove shape deeper than the first concave portion 19c is formed on the left side of the first concave portion 19c of the first supporting plate 19, the shutter main body part 17a is configured so as to perform an opening operation in a state in which contacting areas (touching areas) with the first and second supporting plates 19 and 20 are small. Accordingly, the shutter device 13 is configured, as shown in FIGS. 4B and 4C or by virtual lines in FIG. 11, such that the target chamber 7b and the workpiece chamber 5f are in a communicating state as the shutter 17 is shifted to an open position.

Reference numeral 20e denote a plurality of biasors that are internally installed at rim portions of the continuous hole 20a for pressing the shutter main body part 17a toward the first supporting plate 19 side.

When the shutter device 13 becomes closed after the film forming step (see FIG. 4C) is completed, both the target chamber 7b and workpiece chamber 5f are in a vacuum state. The shutter main body part 17a is not affected by some load based on a difference in atmospheric pressure. The shutter main body part 17a closes the continuous holes 19a and 20a due to the displacement of the guide member 16 toward the right according to the driving of the actuator 14. There is no difference in the atmospheric pressure between both sides of the shutter main body part 17a until the inclined guide plane 17c at the right edge reaches the inclined guide plane 19g of the first supporting plate 19. The shutter main body part 17a is displaced toward the right along the first supporting plate 19, and the leading edge of the inclined guide plane 17c at the shutter side reaches the inclined guide plane 19g at the second supporting plate side. The shutter main body part 17a is thus guided by the inclined guide plane 19g at the second supporting plate side.

Then, the shutter main body part 17a is configured so as to be displaced not only toward the right but also toward the lower side against the biasor 20e, and then is configured so as to move toward the right until the inclined guide planes 17c and 19g, and the movement restriction planes 17d and 19h are thrust onto each other. A movement restriction of the shutter main body part 17a is thus carried out. In this state, the shutter main body part 17a is pressed onto the second supporting plate 20 side so as to be sealed in a closely-contacted manner. And as shown in FIG. 5A, even when the first molding die 5d that is thrust onto the second supporting plate 20 is separated from the mold, the target chamber 7b is well sealed, and therefore a vacuum state can last.

In the embodiment of the present disclosure structured as described above, the film-formed molded piece 1 is manufactured through the primary injection step of forming the first and second molded pieces 2 and 3, the film forming step of forming the first molded piece 2, and the secondary injection step of integrating the first and second molded pieces 2 and 3. The shutter device 13 is provided between the film forming die 7a and the first molding die 5d that are die-matched with each other when a film forming is applied onto the first molded piece 2. The target chamber 7b and the workpiece chamber 5f communicate with one another only when a vacuum film forming step is carried out. The target chamber 7b side thus can last in a vacuum state. As a result, when vacuum film forming is carried out with respect to the first molded piece 2, the first molding die 5d is die-matched with the film forming die 7a, and both target chamber 7b and workpiece chamber 5f are communicated with one another, then the target chamber 7b is maintained in a vacuum state at the process of making both chambers 7b and 5f into a vacuum state (a vacuum process). The vacuum pump P thus can be operated only by a quantity that is required for making the workpiece chamber 5f side into a vacuum state. There is no need for both the target chamber 7b and the workpiece chamber 5f to be shifted from an atmospheric pressure to a vacuum, and to an atmospheric pressure as in the conventional art. Therefore, a manufacturing time (a vacuum process time) can be shortened. Workability also can be improved and a reduction in cost can be achieved.

Moreover, in accordance with the present embodiment, the shutter device 13 is configured such that the first and second supporting plates 19 and 20 are used as a base, and the shutter 17 that is disposed between both plates 19 and 20 is operated to be opened and closed. When the shutter 17 is at the closed position, the shutter 17 can be closed so as to be pressed onto the tabular lower surface of the second supporting plate 20 that has a larger touching area at the workpiece chamber 5f. Therefore, the sealing performance of the target chamber 7b can be enhanced. The maintenance of the vacuum state in the target chamber 7b can also reliably be secured.

When the shutter 17 of the shutter device 13 is in the open position from the closed position, atmospheric pressure at the workpiece chamber 5f side is applied to the shutter main body part 17a that is displaced toward the second supporting plate 20 side that has the larger touching area so as to seal the target chamber 7b into a vacuum state based on the fact that the shutter main body part 17a is displaced to the left by driving the actuator 14. The shutter 17 thus can be pushed (displaced) toward the first supporting plate 19 side based on guidance by the inclined guide planes 17c and 19g according to the shutter main body part 17a displacement toward the left. As a result, a high-sealing performance of the shutter 17 can be secured so as to be closely contacted with the second supporting plate 20 in the closed state. When the shutter 17 is opened, the shutter 17 is displaced toward the side of the first supporting plate 19 that has a smaller touching area. A smooth opening operation of the shutter 17 thus can be performed along the first supporting plate 19. Therefore, the shutter device 13 can acquire excellent operability.

Further, in accordance with the disclosure, the shutter 17 of the shutter device 13 becomes open as the first molding die 5d is die-matched with the film forming die 7a to which the shutter device 13 is provided. After the film forming 2a is applied onto the first molded piece 2, the shutter 17 is shifted toward the closed position before the first molding die 5d is separated from the film forming die 7a. The target chamber 7b side that is closed by the shutter 17 thus can be maintained in the vacuum state. There is no need to repeatedly vacuumize both chambers of the target chamber 7b and the workpiece chamber 5f each time when the film forming step is carried out. Therefore, a manufacturing time can be shortened and the workability can be improved, which contributes to a reduction in cost.

The present disclosure is useful for a vacuum film forming apparatus such as a vacuum evaporation system or a sputtering system, and a vacuum film forming method. Because the shutter device is provided between the first molding die and the film forming die between which die matching is carried out when vacuum film forming is applied onto the first molding die, the sealing performance of the target chamber can be enhanced, and the maintenance of the vacuum state in the target chamber can be reliably secured. Moreover, because the target chamber is maintained in the vacuum state at the vacuum process after both of the target chamber and the workpiece chamber are communicated with one another, the vacuum pump can be operated just by a quantity that is required for making the workpiece chamber side into a vacuum state. Even when the film forming step is repeatedly carried out, the vacuum process time can be shortened. Therefore, the workability can be improved and the cost can be reduced.

1. A vacuum film forming apparatus, comprising:
a target chamber in which a target is disposed for performing a vacuum film forming;
a first mold at a side of the target chamber; and
a second mold that includes a workpiece chamber in which a workpiece is capable of being disposed, wherein:
the first mold and the second mold are structured such that a film being formed onto the workpiece is capable of being carried out by die matching between the first mold and the second mold, and
a shutter device for opening and closing the target chamber is provided to the first mold.

2. The vacuum film forming apparatus according to claim 1, wherein the shutter device comprises:
a base that is supported on an open end of the first mold; and
an opening and closing member that opens and closes an opening of the base so as to control communication between the target chamber and the workpiece chamber.

3. The vacuum film forming apparatus according to claim 2, wherein the base comprises:
a first supporting plate that is supported to a side of the first mold; and
a second supporting plate provided so as to be laminated onto the first supporting plate, wherein the opening and closing member is disposed so as to be freely movable between both supporting plates.

4. The vacuum film forming apparatus according to claim 3, wherein:
between the opening and closing member and the base is a guide that guides the opening and closing member to be displaced toward a side of the second supporting plate while moving the opening and closing member into a position in which the opening is closed, and
the guide places the opening and closing member into a state in which the opening and closing member touches the side of the second supporting plate in a sealed manner so as to be spaced from a plate surface of the first supporting plate in the position in which the opening is closed so that a vacuum state is maintained in the target chamber.

5. The vacuum film forming apparatus according to claim 3, wherein, while moving from a closed state to an open state, the opening and closing member is displaced toward a plate surface side of the first supporting plate by receiving atmospheric pressure from the workpiece chamber that is thrust onto the second supporting plate in a sealed manner.

6. A vacuum film forming method, comprising the successive steps of:
carrying out die matching between a first mold that is located at a side of a target chamber in which a target is disposed to perform vacuum film forming, and a second mold that includes a workpiece chamber in which a workpiece is disposed; and
forming a film onto the workpiece, wherein:
when a shutter device that is provided to the first mold in order to open and close the target chamber is shifted to an open position while die matching of the molds is carried out and the film is formed, a vacuum film forming is applied onto the workpiece, and
the shutter is shifted to a closed position after the vacuum film forming is completed until a following die matching is carried out so that the target chamber is maintained in a vacuum state.

7. The vacuum film forming apparatus according to claim 4, wherein, while moving from a closed state to an open state, the opening and closing member is displaced toward a plate surface side of the first supporting plate by receiving atmospheric pressure from the workpiece chamber that is thrust onto the second supporting plate in a sealed manner.

8. The vacuum film forming apparatus according to claim 3, wherein:
an inclined guide plane that is formed at an edge of the opening and closing member touches an inclined guide plane of the first supporting plate, and a movement restriction plane of the opening and closing member touches a movement restriction plane of the first supporting plate, and an upper side inclined plane of the opening and closing member touches an inclined plane of the first supporting plate when the opening is closed.

9. The vacuum film forming apparatus according to claim 3, wherein:
an inclined guide plane that is formed at an edge of the opening and closing member is pressed onto a bottom surface of a concave portion of the first supporting plate when the opening is opened.

10. The vacuum film forming method according to claim 6, wherein the shutter device comprises:
a base that is supported on an open end of the first mold; and
an opening and closing member that opens and closes an opening of the base so as to control communication between the target chamber and the workpiece chamber.

11. The vacuum film forming method according to claim 10, wherein the base comprises:
a first supporting plate that is supported to a side of the first mold; and
a second supporting plate provided so as to be laminated onto the first supporting plate, wherein the opening and closing member is disposed so as to be freely movable between both supporting plates.

12. The vacuum film forming method according to claim 11, wherein:
between the opening and closing member and the base is a guide that guides the opening and closing member to be displaced toward a side of the second supporting plate while moving the opening and closing member into a position in which the opening is closed, and
the guide places the opening and closing member into a state in which the opening and closing member touches the side of the second supporting plate in a sealed manner so as to be spaced from a plate surface of the first supporting plate in the position in which the opening is closed so that a vacuum state is maintained in the target chamber.

13. The vacuum film forming method according to claim 11, wherein, while moving from a closed state to an open state, the opening and closing member is displaced toward a plate surface side of the first supporting plate by receiving atmospheric pressure from the workpiece chamber that is thrust onto the second supporting plate in a sealed manner.

14. The vacuum film forming method according to claim 12, wherein, while moving from a closed state to an open state, the opening and closing member is displaced toward a plate surface side of the first supporting plate by receiving atmospheric pressure from the workpiece chamber that is thrust onto the second supporting plate in a sealed manner.

15. The vacuum film forming method according to claim 11, wherein:
an inclined guide plane that is formed at an edge of the opening and closing member touches an inclined guide plane of the first supporting plate, and a movement restriction plane of the opening and closing member touches a movement restriction plane of the first supporting plate, and an upper side inclined plane of the opening and closing member touches an inclined plane of the first supporting plate when the opening is closed.

16. The vacuum film forming method according to claim 11, wherein:
an inclined guide plane that is formed at an edge of the opening and closing member is pressed onto a bottom surface of a concave portion of the first supporting plate when the opening is opened.
